(19) United States
(12) Patent Application Publication
(10) Pub. No.: US 2022/0168923 A1
(43) Pub. Date: Jun. 2, 2022

(54) PRECAST CONCRETE PULLBOX WITH KNOCKOUT SECTION

(71) Applicant: Oldcastle Infrastructure, Inc., Atlanta, GA (US)

(72) Inventors: Jerry Higgenbotham, Fulshear, TX (US); Stacy Crow, Boerne, TX (US); Timothy Calvert, Hockley, TX (US)

(21) Appl. No.: 17/540,024

(22) Filed: Dec. 1, 2021

Related U.S. Application Data
(60) Provisional application No. 63/120,087, filed on Dec. 1, 2020.

(51) Int. Cl. B28B 23/02; B28B 7/00

(52) U.S. Cl. CPC B28B 23/02; H02G 3/085; B28B 7/0064

(57) ABSTRACT

Pullboxes for enclosing utility components and methods of manufacturing the same are provided. In some embodiments, a pullbox has at least one knockout section that is an area of the sidewall of the pullbox that has a reduced thickness. Apertures to receive conduits through the knockout section can be created with far less effort that traditional pullboxes. The conduits allow various utility components to pass through the wall of the pullbox. In addition, the discrete knockout section preserves the structural integrity of the pullbox, and the knockout section can have features that promote certain actions during a molding process for manufacturing the pullbox. Additional features such as a reinforcement mesh embedded in the pullbox in a certain manner and location are also described herein.

### CROSS-REFERENCE TO RELATED APPLICATIONS

This U.S. Non-Provisional Application claims the benefit of priority from U.S. Provisional Patent Application Ser. No. 63/120,087 filed Dec. 1, 2020, the entire disclosure of which is hereby incorporated by reference.

### FIELD

The present disclosure relates to a pullbox for enclosing utilities that has a knockout section with a reduced thickness so that conduit apertures can be more easily created through the knockout section and provide access to the utilities.

### BACKGROUND

Pullboxes are generally positioned in the ground and house various conduits and wires for utilities such as electrical systems, plumbing systems, water systems, etc. A manhole cover placed on top of the pullbox selectively encloses the utilities within the pullbox. In some prior art systems, the pullbox is cast in place, meaning forms are positioned at the in-ground location, and concrete is poured into the forms to create the pullbox. With in-place casting, various conduits can extend through the forms based on the positions of wires and conduits outside of the pullbox and the actual or expected positions of utilities within the pullbox. Then, when the concrete is poured, the conduits are in the correct position to provide access to the utilities.

One trend in concrete structures is manufacturing structures such as pullboxes offsite in a controlled environment and then delivering the precast concrete structure to the construction site for final installation. Precast concrete offers many advantageous such as quality control, speed of production, and reduced costs. However, in the case of a pullbox, the structure is made offsite without knowing precisely where a conduit or wire is supposed to pass through the pullbox and into the pullbox. Thus, once installed, part of the wall of the pullbox is chiseled or drilled to create an ad hoc aperture through the wall of the pullbox to allow conduit or wires to pass through the pullbox. Creating these apertures requires considerable time and related expense and can cause unintended effects such as crack propagation through the entire body of the pullbox. Thus, there is a need for a precast pullbox that can accommodate the creation of apertures through the pullbox for conduits and wires.

### SUMMARY

The present disclosure provides a precast concrete pullbox, and methods for manufacturing the same, that has one or more knockout sections with reduced thickness through which to create an aperture for conduits or wires. The reduced thickness equates to reduced effort to create such apertures, and the knockout sections also limit the propagation of any cracks or unintended consequences of creating an aperture through the pullbox. Other benefits and aspects of the disclosure are described in further detail below.

It is an aspect of various embodiments of the present disclosure to provide a knockout section with a taper surface that helps release the pullbox from a mold during manufacturing. A taper surface extends outwardly from a surface of the knockout section to an outer surface of a sidewall of the pullbox. If this surface were not tapered and were instead perpendicular to the surface of the knockout section, then the force required to separate the pullbox from the mold would have to overcome friction and shear forces created by the perpendicular surface and the mold. Instead, with a tapered surface, the shear forces and friction are reduced, and less force is needed to release the pullbox from a mold. The taper surface may also prevents accumulation of moisture on the outer surface of the pullbox. In addition, the taper surface can have an arcuate top portion and/or bottom portion to further promote these aspects of the disclosure.

It is a further aspect of various embodiments of the present disclosure to provide a reinforcement mesh that is embedded in the sidewall of the pullbox. The reinforcement mesh can have crisscrossing members made from a material such as metal to provide further strength to the pullbox. In some embodiments, the members and the spaces therebetween are positioned in a predetermined fashion with respect to the knockout section. Then, an end user with knowledge of the position of the reinforcement mesh can chisel, drill, or otherwise create an aperture through the knockout section and through a space between members to avoid eliminating any portion of the reinforcement mesh or exposing the reinforcement mesh to the environment.

It is a further aspect of various embodiments of the present disclosure to provide knockout sections in the sidewall of a pullbox but maintain the overall structural integrity of the pullbox. When viewed from above, the knockout section extends around a portion of the perimeter of the pullbox, and multiple knockout sections can extend along multiple portions of the perimeter. In various embodiments, the portion or portions of the perimeter occupied by the knockout sections is less than the portion or portions occupied by the non-knockout sections. Thus, even if apertures are created in all knockout sections and the knockout sections provide less structural support to the overall pullbox, the non-knockout sections maintain the integrity of the pullbox.

One specific embodiment of the present disclosure is a precast concrete pullbox for enclosing utilities, comprising at least one sidewall defining an enclosed volume; a reinforcement mesh embedded in the at least one sidewall, wherein the reinforcement mesh comprises a plurality of horizontal members crossing a plurality of vertical members to form spaces between the horizontal and vertical members; and a knockout section with a reduced thickness positioned in an outer surface of the at least one sidewall, wherein a taper surface extends outwardly from a surface of the knockout section to the outer surface of the at least one sidewall, and the taper surface has an arcuate top portion and an arcuate bottom portion to promote the release of the pullbox from a mold.

In some embodiments, the knockout section is part of a plurality of knockout sections, and the plurality of knockout sections extends around a perimeter of the at least one sidewall that is less than a perimeter of non-knockout sections to maintain structural integrity of the pullbox. In various embodiments, a horizontal member of the plurality of horizontal members is vertically aligned with a corner between a side edge of the taper surface and the arcuate top portion, and a vertical member of the plurality of vertical members is horizontally aligned with the side edge of the taper surface so that a location of the spaces between the horizontal and vertical members is predetermined relative to the knockout section.

In various embodiments, the taper surface has a constant slope from the surface of the knockout section to the outer surface of the at least one sidewall. In some embodiments, the at least one sidewall is a single sidewall having a cylindrical shape. In various embodiments, the pullbox further comprises a cover body positioned on the upper end of the at least one sidewall, wherein the cover body defines an opening in which the cover is disposed to provide selective access to the enclosed volume. In some embodiments, the pullbox further comprises a second reinforcement mesh positioned in a bottom wall that defines the enclosed volume, wherein the second reinforcement mesh comprises a plurality of first members crossing a plurality of second members, wherein the members are made from rebar. In various embodiments, the pullbox further comprises a cover positioned on an upper end of the at least one sidewall to further define the enclosed volume and provide selective access to the enclosed volume.

Another particular embodiment of the present disclosure is a method of forming a precast concrete pullbox for enclosing utility components, comprising (i) providing a mold having a central core and at least one mold plate, wherein the at least one mold plate has an inwardly-oriented protrusion that defines a knockout section with a reduced thickness; (ii) wrapping a reinforcement mesh around the central core, wherein the reinforcement mesh comprises a plurality of horizontal members crossing a plurality of vertical members; (iii) positioning the at least one mold plate around the reinforcement mesh and the central core; (iv) pouring a concrete mix into a space between the central core and the at least one mold plate and allowing the concrete mix to cure; and (v) moving the at least one mold plate away from the central core with a predetermined force to release a resulting pullbox that has the knockout section, wherein a taper surface extends outwardly from a surface of the knockout section to an outer surface of at least one sidewall of the pullbox, and the taper surface has an arcuate top portion and an arcuate bottom portion to promote release of the pullbox from the mold.

In some embodiments, the method further comprises (vi) securing a spacer to a horizontal member or a vertical member of the reinforcement mesh to offset the reinforcement mesh from an outer surface of the central core. In various embodiments, the at least one mold plate comprises a first mold plate and a second mold plate, wherein the protrusion extends from an inner surface of the first mold plate to define the knockout section, and a second protrusion extends from an inner surface of the second mold plate to define a second knockout section.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non-inclusion of elements or components. Additional aspects of the present disclosure will become more readily apparent from the Detailed Description, particularly when taken together with the drawings.

The above-described embodiments, objectives, and configurations are neither complete nor exhaustive. As will be appreciated, other embodiments of the disclosure are possible using, alone or in combination, one or more of the features set forth above or described in detail below.

The phrases “at least one,” “one or more,” and “and/or,” as used herein, are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification and claims are to be understood as being modified in all instances by the term “about.”

The term “a” or “an” entity, as used herein, refers to one or more of that entity. As such, the terms “a” (or “an”), “one or more,” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and claims themselves.

### BRIEF DESCRIPTION OF THE DRAWINGS

The accompanying drawings, which are incorporated in and constitute a part of the specification, illustrate embodiments of the disclosure and together with the Summary given above and the Detailed Description of the drawings given below, serve to explain the principles of these embodiments. In certain instances, details that are not necessary for an understanding of the disclosure or that render other details difficult to perceive may have been omitted. It should be understood, of course, that the disclosure is not necessarily limited to the particular embodiments illustrated herein. Additionally, it should be understood that the drawings are not necessarily to scale.

FIG. 1 is a cross-sectional, side elevation view of a prior art pullbox; FIG. 2A is a side elevation view of a pullbox according to an embodiment of the present disclosure;

FIG. 2B is a front elevation view of a knockout section according to an embodiment of the present disclosure;

FIG. 2C is a side elevation view of a knockout section according to an embodiment of the present disclosure;

FIG. 3 is a top plan view of a pullbox according to an embodiment of the present disclosure;

FIG. 4 is a side elevation view of a reinforcement mesh according to an embodiment of the present disclosure;

FIG. 5 is a side elevation view of the pullbox in FIG. 2 showing the reinforcement mesh in FIG. 4 according to an embodiment of the present disclosure;

FIG. 6 is a top plan view of the pullbox in FIG. 3 showing a further reinforcement mesh according to an embodiment of the present disclosure;

FIG. 7A is a top plan view of a cover according to an embodiment of the present disclosure;

FIG. 7B is a cross-sectional, side elevation view of the cover in FIG. 7A according to an embodiment of the present disclosure;

FIG. 8A is a top plan view of another cover showing a reinforcement mesh according to an embodiment of the present disclosure;

FIG. 8B is a cross-sectional, side elevation view of the cover in FIG. 8A according to an embodiment of the present disclosure;

FIG. 9A is a perspective view of a mold for manufacturing a pullbox according to an embodiment of the present disclosure; and

FIG. 9B is another perspective view of a mold for manufacturing a pullbox according to an embodiment of the present disclosure.

Similar components and/or features may have the same reference label. Further, various components of the same type may be distinguished by following the reference label by a letter that distinguishes among the similar components. If only the first reference label is used, the description is applicable to any one of the similar components having the same first reference label irrespective of the second reference label.

A list of the various components shown in the drawings and associated numbering is provided herein:

| Component No. | Component |
|---|---|
| 10 | Pullbox System |
| 12 | Pullbox |
| 14 | Sidewall |
| 16 | Bottom Wall |
| 18 | Enclosed Volume |
| 20 | Upper Opening |
| 22 | Cover |
| 24 | Lower Opening |
| 26 | Ground Rod |
| 28a, 28b | Conduit |
| 30 | Knockout Section |
| 32 | Sidewall Thickness |
| 34 | Knockout Depth |
| 36 | Lift Feature |
| 38 | Center Surface |
| 40 | Taper Surface |
| 41a | Top Portion |
| 41b | Bottom Portion |
| 41c | Left Side Portion |
| 41d | Right Side Portion |
| 42 | Inner Edge |
| 44 | First Height |
| 46 | Second Height |
| 48 | Outer Edge |
| 50 | First Height |
| 52 | Second Height |
| 54 | Vertical Taper Angle |
| 56 | Horizontal Taper Angle |
| 58 | Knockout Perimeter |
| 60 | Pullbox Perimeter |
| 62 | Reinforcement Mesh |
| 64 | Horizontal Member |
| 66 | Vertical Member |
| 68 | Reinforcement Mesh |
| 70 | First Member |
| 72 | Second Member |
| 74 | Cover Body |
| 76 | Lifting Lugs |
| 78 | Reinforcement Mesh |
| 80 | Reinforcement Member |
| 82 | Mold |
| 84 | Central Core |
| 86 | Mold Plate |
| 88 | Protrusion |
| 90 | Spacer |
| 92 | Bottom Plate |

### DETAILED DESCRIPTION

The present disclosure has significant benefits across a broad spectrum of endeavors. It is the Applicant's intent that this specification and the claims appended hereto be accorded a breadth in keeping with the scope and spirit of the disclosure being disclosed despite what might appear to be limiting language imposed by the requirements of referring to the specific examples disclosed. To acquaint persons skilled in the pertinent arts most closely related to the present disclosure, a preferred embodiment that illustrates the best mode now contemplated for putting the disclosure into practice is described herein by, and with reference to, the annexed drawings that form a part of the specification. The exemplary embodiment is described in detail without attempting to describe all of the various forms and modifications in which the disclosure might be embodied. As such, the embodiments described herein are illustrative, and as will become apparent to those skilled in the arts, may be modified in numerous ways within the scope and spirit of the disclosure.

Although the following text sets forth a detailed description of numerous different embodiments, it should be understood that the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning.

Various embodiments of the present disclosure are described herein and as depicted in the drawings. It is expressly understood that although the figures depict pullboxes, knockout sections, and/or reinforcement mesh, the present disclosure is not limited to these embodiments. Additional information about the present disclosure can be found in the attached Appendix, which is incorporated by reference in its entirety.

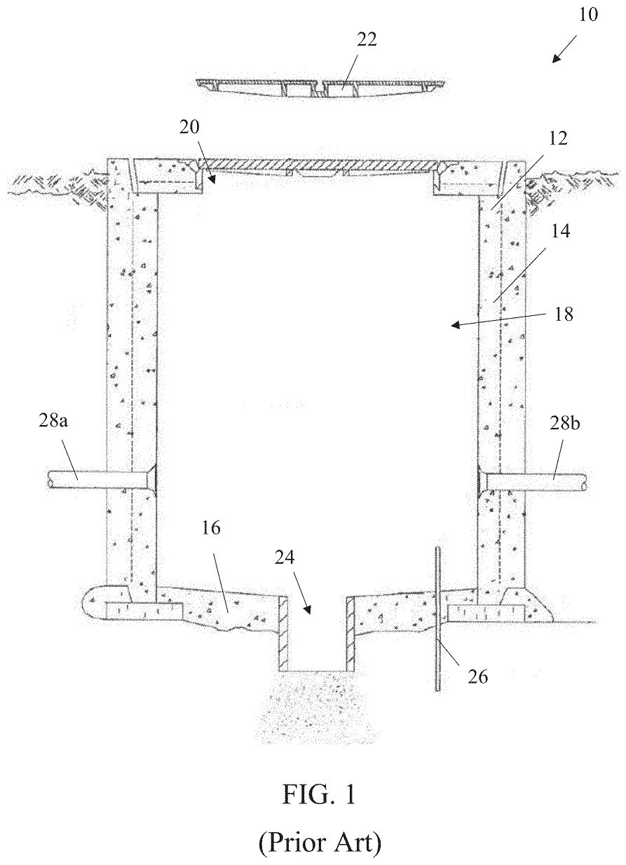

Now referring to FIG. 1, a cross-sectional side elevation view of a prior art, poured-in-place pullbox system 10 is provided. Generally, a pullbox system 10 is positioned below grade and is intended to house and protect various conduits and wires for electrical systems, plumbing systems, water systems, etc. The system 10 comprises a pullbox 12, which has one or more sidewalls 14 that extend upward from a bottom wall 16 where the walls 14, 16 define an enclosed volume 18. In some embodiments, only one or more sidewalls 14 define the enclosed volume 18. The upper end of the pullbox 12 can remain open, and a cover system can be positioned on the upper end to provide selective access to the enclosed volume 18. Specifically, a body of the cover system can define an upper opening 20 that receives a cover 22 to selectively close the volume 18, and keep out animals, weather, people, and anything else that can be detrimental to the components in the enclosed volume 18. In other embodiments, the cover 22 can be directly placed on the upper end of the pullbox 12. Also shown in FIG. 1 are a lower opening 24 that allows residual fluids or gases to drain from the enclosed volume 18 as well as a ground rod 26 that can serve as an electrical ground for components in the enclosed volume 18.

FIG. 1 also shows conduits 28a, 28b extending through the sidewall 14 of the pullbox 10. These conduits 28a, 28b join the systems within the enclosed volume 18 to components outside of the enclosed volume 18. Once positioned, the conduits 28a, 28b can be grouted in place or otherwise sealed to prevent moisture and other elements from entering the pullbox. However, having the conduits 28a, 28b pass through the sidewall presents a number of issues as described above, including requiring a substantial amount of effort to create the aperture through the sidewall and causing negative effects on the integrity of the pullbox 12 and overall pullbox system 10.

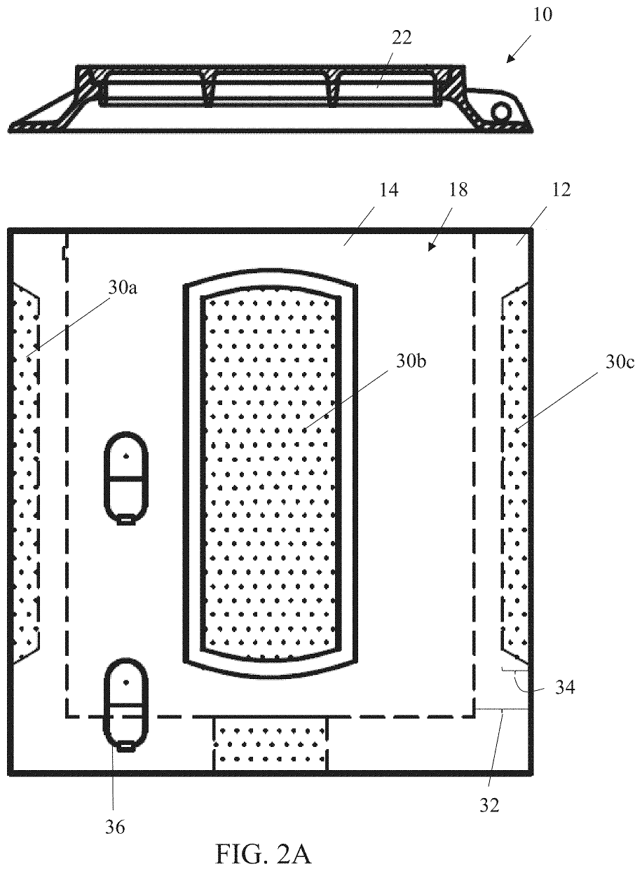

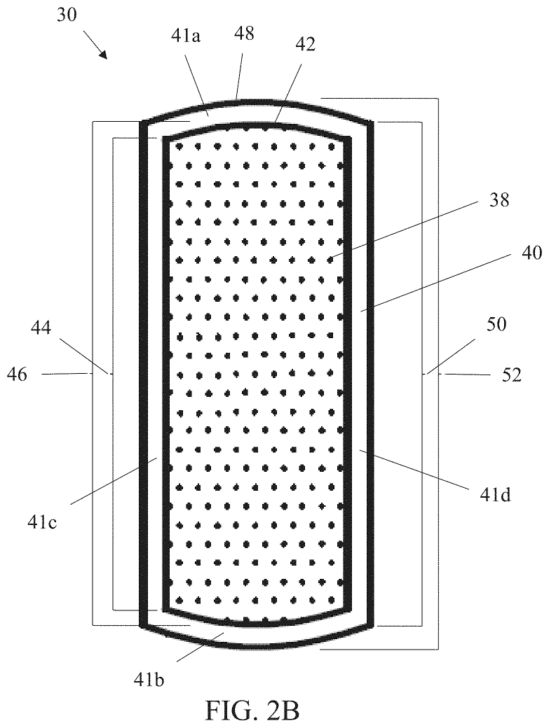

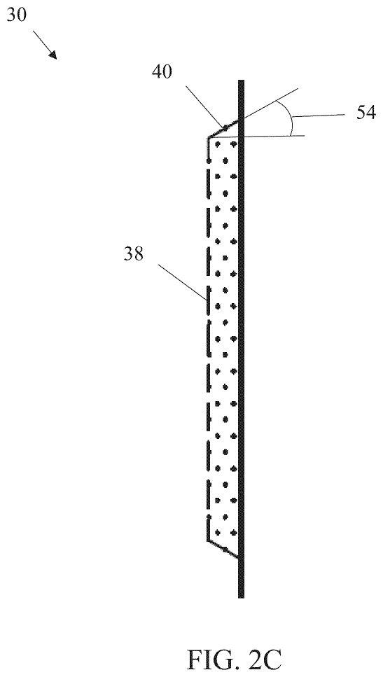

Now referring to FIG. 2A, a side elevation view of a novel precast pullbox system 10 is provided. The system 10 has a pullbox 12 with multiple knockout sections 30a-30c extending into an outer surface of the sidewall 14. When a conduit or other similar structure needs to pass through the sidewall 14 and into the enclosed volume 18 of the pullbox 12, apertures can be created in one or more of these knockout sections 30a-30c to receive the conduit. The sidewall 14 has a thickness 32, and the knockout sections 30a-30c extend into the sidewall 14 by a depth 34 that is less than the thickness 32 of the sidewall 14. In some embodiments, the depth 34 is between approximately 40-60% of the sidewall thickness 32. In various embodiments, the depth 34 is approximately 50% of the sidewall thickness 32. In further embodiments, the depth 34 is greater than 40% of the sidewall thickness 32. The knockout sections 30a-30c can also be described as a portion of the sidewall with a reduced thickness where the thickness is the inverse of the depth described herein. For example, if the depth of a knockout section is 40% of the sidewall thickness 32, then the thickness of the knockout section is 60% of the sidewall thickness 32.

With the reduced thickness in the region of the knockout sections 30a-30c, less effort is needed to create apertures to receive conduits or other similar structures. In addition, creating apertures in the knockout sections 30a-30c preserves the integrity of the overall pullbox 12 and pullbox system 10 as defects such as cracks cannot propagate easily from the knockout sections 30a-30c to other portions of the sidewall 14. Also shown in FIG. 2A is a lift feature 36 such as a pullrope that is partially embedded in the sidewall 18 of the pullbox 12 during a manufacturing process. One or more lift features 36 can be used to lift, maneuver, and lower the pullbox 12 into its final position.

While embodiments of the pullbox 12 are described as precast concrete, it will be appreciated that the pullbox 12 can be made from any type of material alone or in combination with other materials such as fiberglass, plastic, etc.

Now referring to FIG. 2B, a front elevation view of a knockout section 30 is provided. The knockout section 30 has a center surface 38 where an aperture can be created, and a taper surface 40 transitions from the surface 38 of the knockout section 30 to the outer surface of the other portions of the sidewall. The knockout section 30 has a larger height dimension than width dimension such that an aperture can be created at various locations along the height dimension of the pullbox. For instance, a conduit for plumbing may require conduit at a different height than a conduit for an electrical wire. In addition, the pullbox system can have multiple knockout sections arrayed around the outer surface of the sidewall to accommodate different conduits entering the pullbox from different lateral directions.

The taper surface 40 has a shape that allows for an easier release from a mold as described in further detail below with respect to a manufacturing process. The taper surface 40 as shown in FIG. 2B tapers outwardly from the knockout section 30 to the other portions of the sidewall of the pullbox. Moreover, the taper surface 40 has an arcuate top portion 41a and an arcuate bottom portion 41b. Specifically, the taper surface 40 has an inner edge 42 that ranges from a first height 44 at the corners of the arcuate portions 41a, 41b to a larger second height 46 at the centers of the arcuate portions 41a, 41b. Moreover, the taper surface 40 has an outer edge 48 that ranges from a first height 50 at the corners of the arcuate portions 41a, 41b to a larger second height 52 at the centers of the arcuate portions 41a, 41b. Further still, the taper surface 40 has substantially straight side portions 41c, 41d as shown in FIG. 2B. While the taper surface 40 is depicted as having a constant slope, it will be appreciated that the taper surface 40 can have any slope including a slope that blends into the center surface of the knockout section and/or the outer surface of the sidewall. The arcuate portions can have a constant radius of curvature in some embodiments.

However it will be appreciated that in various embodiments, the arcuate portions can have non-constant curvature, non-continuous curvature, a disjointed shape such as a polygonal shape, etc. Further still, in some embodiments, the bottom portion can simply have two flat portion that taper from a side of the knockout portion to a center of the knockout portion.

Now referring to FIG. 2C, a side elevation view of a knockout section 30 is provided. As shown, the knockout section 30 has a center surface 38 and a taper surface 40. The top and bottom of the taper surface 40 slopes outwardly at a taper angle 54. In some embodiments, the taper angle 54 is between approximately 20 and 40 degrees. In various embodiments, the taper angle 54 is approximately 30 degrees. The taper angle 54 can also be different for the top and bottom portions of the taper surface 40.

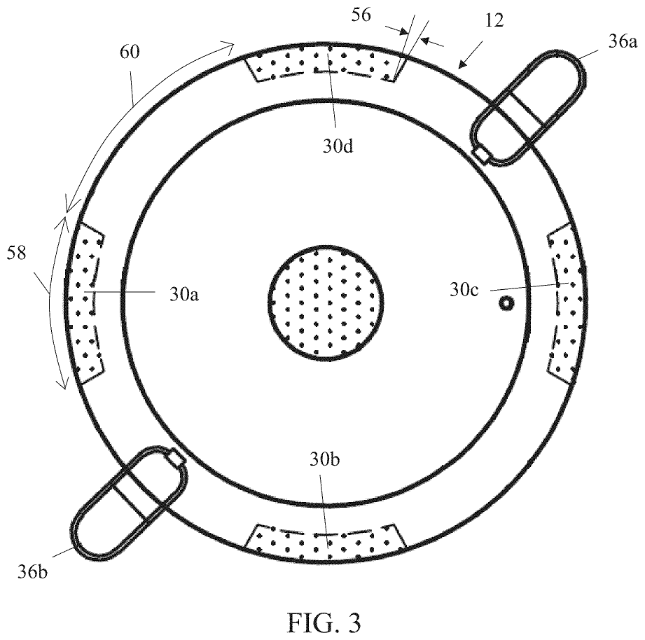

Now referring to FIG. 3, a top plan view of a precast pullbox 12 is provided. The pullbox 12 in this embodiment has four knockout sections 30a-30d equally spaced around an outer perimeter of the sidewall of the pullbox 12. From this view, the left and right side portions of the taper surface are sloped outwardly by an angle 56. In some embodiments, this angle 56 is between approximately 10 and 30 degrees. In various embodiments, this angle 56 is approximately 20 degrees. Again, this outward slope promotes release of the pullbox during the manufacturing process.

Each knockout section 30a-30d extends around a portion 58 of the perimeter of the sidewall of the pullbox 12, and non-knockout sections of the sidewall extend around a larger portion 60. The non-knockout sections of the sidewall have a larger thickness than the knockout sections 30a-30d as described above, and thus, the structural integrity of the pullbox 12 is retained, even with the knockout sections 30a-30d extending into the sidewall and even with apertures extending through the knockout sections 30a-30d themselves. Also shown in FIG. 3 are multiple lift features 36a, 36b positioned on opposing sides of the pullbox 12.

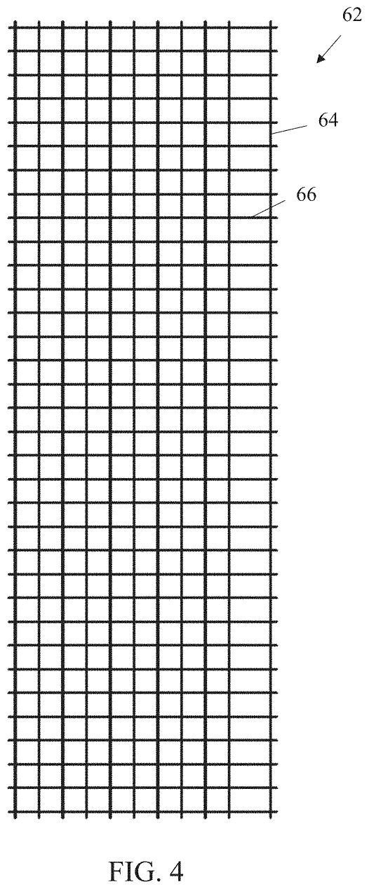

Referring now to FIG. 4, a side elevation view of a reinforcement mesh 62 is provided. Generally, the reinforcement mesh 62 comprises a plurality of horizontal members 64 and a plurality of vertical members 66 that intersect each other to form a mesh or grid. In this embodiment, the horizontal dimension of the reinforcement mesh 62 is larger than the vertical dimension. The members 64, 66 can also be referred to as first and second members. It will be appreciated that the reinforcement mesh 62 and other meshes described herein can be made from metal rebar. In addition, the reinforcement mesh 62 can be made from other materials such as fiberglass, plastic, prestressed carbon fiber, etc.

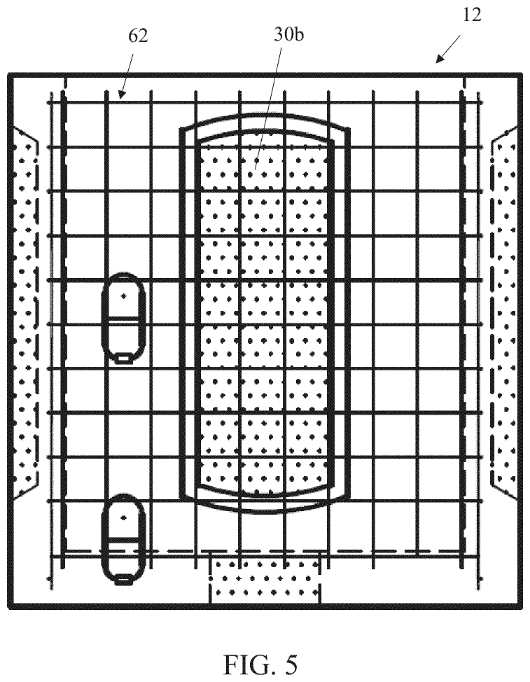

Referring now to FIG. 5, a front elevation view of a pullbox 12 is provided with a reinforcement mesh 62 shown. The reinforcement mesh 62 is wrapped such that the ends of the horizontal members meet or overlap. Moreover, the reinforcement mesh 62 is positioned in a mold and embedded in the material of the pullbox 12 such that the reinforcement mesh 62 is between the surface of the knockout section and the inner surface of the sidewall. Thus, the reinforcement mesh 62 is not exposed at any surface of the pullbox 12.

When an aperture is created in the knockout section 30b, the user can position the aperture in a space between the members of the reinforcement mesh 62. As shown in FIG. 5, these spaces are square shaped. If a user understands the location of the spaces over the knockout section, then the user can create apertures without contacting or destroying the reinforcement mesh 62. To help the user understand where the spaces are located with respect to the knockout section 30b, the reinforcement mesh can have its members spaced in a particular manner. As shown in FIG. 5, the three spaces of the reinforcement mesh 62 extend across a horizontal dimension of the knockout section 30b. In addition, a horizontal member is aligned with a top corner of the knockout section 30b in the vertical direction. Given that the spaces are square shapes, a user will understand the layout of the reinforcement mesh 62 behind the knockout section 30b and can select a location of an aperture appropriately. In other embodiments, the aperture may need to be larger than a single space between members of the reinforcement mesh 62. Thus, a user with knowledge of the position of the reinforcement mesh 62 behind the knockout section 30b can select a location to minimize the number of members that need to be cut or removed to accommodate the larger aperture.

In yet further embodiments, the mold described elsewhere herein can have a protrusion or depression that creates a corresponding depression or protrusion on the knockout portion 30b that indicates the location of the reinforcement mesh 62. Thus, the resulting knockout portion 30b can have a grid like series of depressions and/or protrusions, and a user can create an aperture between the depression and/or protrusions to create an aperture between members of the reinforcement mesh 62.

Referring now to FIG. 6, a top plan view of the pullbox 12 showing another reinforcement mesh 68 is provided. This reinforcement mesh 68 is located in the bottom wall of the pullbox 12 and has a plurality of first members 70 and a plurality of second members 72 arranged in a grid pattern. The reinforcement mesh 68 is arranged such that no members 70, 72 overlap the knockout sections or the lower opening in this view and is arranged such that at least two members 70, 72 intersect below one or more of the lift features to reinforce the bottom wall closest to the lift features. In some embodiments, the lift features 36a, 36b can loop through one or more member 70, 72 or even members of the mesh 62 shown in FIG. 5.

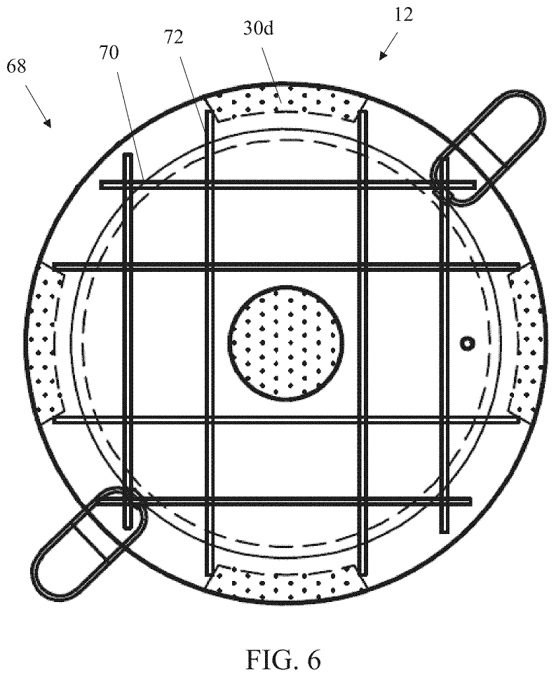

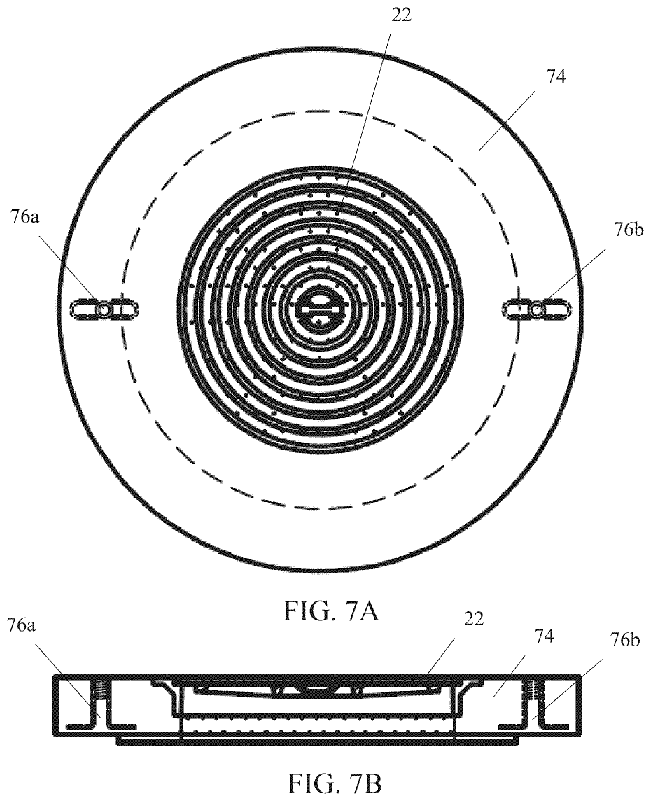

Referring now to FIGS. 7A and 7B, top plan and side elevation views, respectively, of a cover 22 and cover body 74 are provided. As described above, a cover 22 alone or a cover 22 and an additional structure can cover an upper opening of the pullbox. As shown, the cover body 74 can cover the upper opening of the pullbox, and then, the cover 22 can be selectively positioned and removed from the cover body 74 to provide selective access to the enclosed volume. Also shown are lifting lugs 76a, 76b for handling the cover body 74.

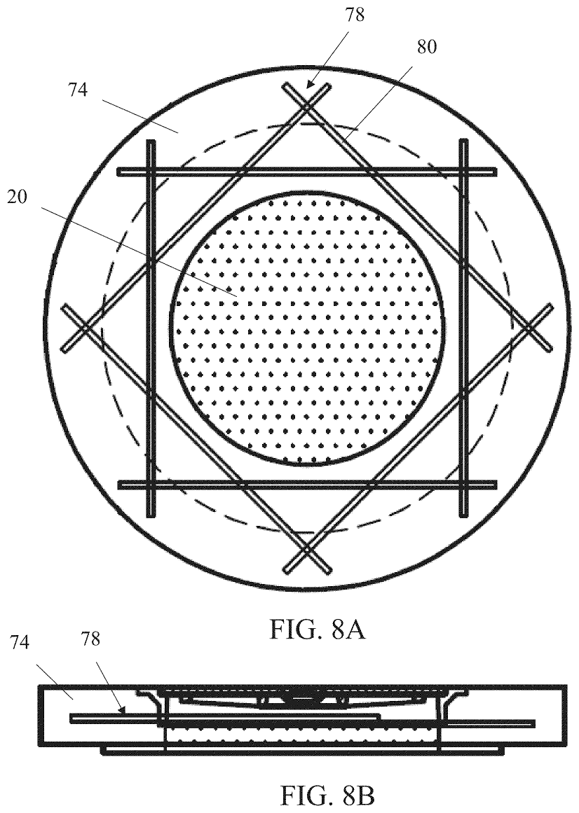

Referring now to FIGS. 8A and 8B, top plan and side elevation views, respectively, of another embodiment of the cover 22 and cover body 74 are provide. This embodiment is configured to accommodate larger forces imposed on the cover 22 and cover body 74 such as vehicle traffic. To accommodate these forces, a reinforcement mesh 78 with a plurality of members 80 is positioned in the cover body 74. At least two of the members 80 intersect with each other to provide additional strength to the cover body 74.

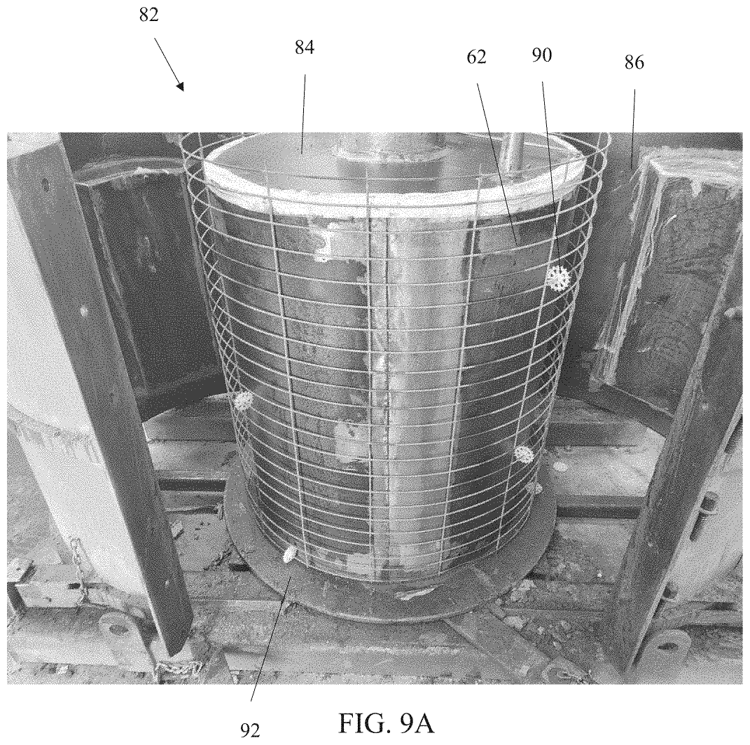

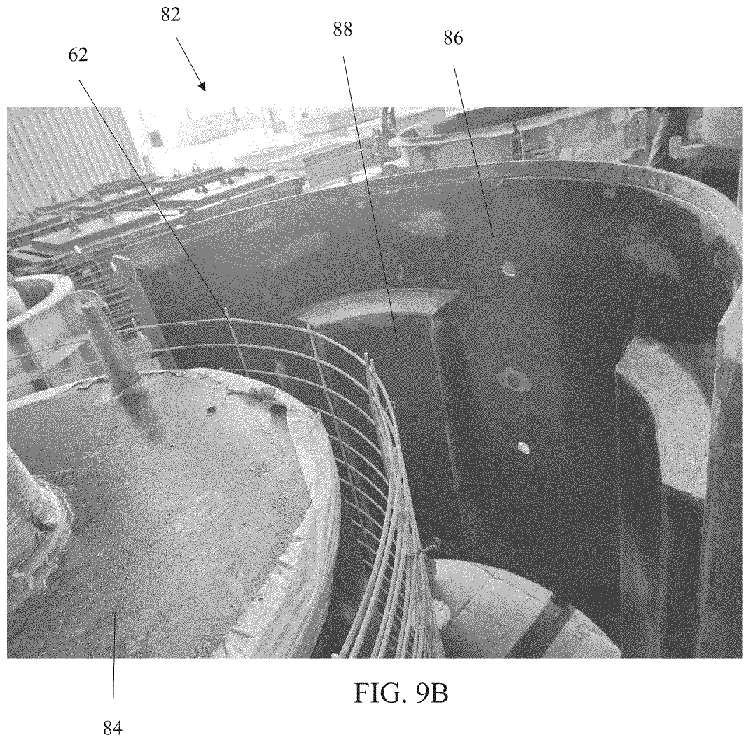

Referring now to FIGS. 9A and 9B, perspective views of a mold 82 are provided. The mold 82 generally comprises a central core 84 that defines the inner surface of the pullbox, one or more mold plates 86 that define the outer surface of the pullbox, and a bottom plate 92 that defines a bottom surface of the pullbox. During preparation of the mold 82, a reinforcement mesh 62 is wrapped around the central core 84, and one or more spacers 90 are connected to the reinforcement mesh 62 to establish the distance between the mesh 62 and the core 84. Then, the one or more mold plates 86 are closed around the mesh 62 and core 84. The mold plates 86 can have one or more protrusions 88 that correspond to a knockout section as described herein. A concrete mix is poured in the open top end of the mold 82 and allowed to cure. The shape of the knockout section allows the mold plates 86 to be more easily removed and to release the pullbox from the mold 82.

The description of the present disclosure has been presented for purposes of illustration and description, but is not intended to be exhaustive or limiting of the disclosure to the form disclosed. Many modifications and variations will be apparent to those of ordinary skill in the art. The embodiments described and shown in the figures were chosen and described in order to best explain the principles of the disclosure, the practical application, and to enable those of ordinary skill in the art to understand the disclosure.

While various embodiments of the present disclosure have been described in detail, it is apparent that modifications and alterations of those embodiments will occur to those skilled in the art. Moreover, references made herein to “the present disclosure” or aspects thereof should be understood to mean certain embodiments of the present disclosure and should not necessarily be construed as limiting all embodiments to a particular description. It is to be expressly understood that such modifications and alterations are within the scope and spirit of the present disclosure, as set forth in the following claims.

What is claimed is:

1. A precast concrete pullbox for enclosing utilities, comprising:
at least one sidewall defining an enclosed volume;
a reinforcement mesh embedded in said at least one sidewall, wherein said reinforcement mesh comprises a plurality of horizontal members crossing a plurality of vertical members to form spaces between said horizontal and vertical members; and
a knockout section with a reduced thickness positioned in an outer surface of said at least one sidewall, wherein a taper surface extends outwardly from a surface of said knockout section to said outer surface of said at least one sidewall, and said taper surface has an arcuate top portion and an arcuate bottom portion to promote the release of said pullbox from a mold.

2. The precast concrete pullbox of claim 1, wherein said knockout section is part of a plurality of knockout sections, and said plurality of knockout sections extends around a perimeter of said at least one sidewall that is less than a perimeter of non-knockout sections to maintain structural integrity of said pullbox.

3. The precast concrete pullbox of claim 1, wherein a horizontal member of said plurality of horizontal members is vertically aligned with a corner between a side edge of said taper surface and said arcuate top portion, and a vertical member of said plurality of vertical members is horizontally aligned with said side edge of said taper surface so that a location of said spaces between said horizontal and vertical members is predetermined relative to said knockout section.

4. The precast concrete pullbox of claim 1, wherein said taper surface has a constant slope from said surface of said knockout section to said outer surface of said at least one sidewall.

5. The precast concrete pullbox of claim 1, wherein said at least one sidewall is a single sidewall having a cylindrical shape.

6. The precast concrete pullbox of claim 1, further comprising a cover body positioned on said upper end of said at least one sidewall, wherein said cover body defines an opening in which said cover is disposed to provide selective access to said enclosed volume.

7. The precast concrete pullbox of claim 1, further comprising a second reinforcement mesh positioned in a bottom wall that defines said enclosed volume, wherein said second reinforcement mesh comprises a plurality of first members crossing a plurality of second members, wherein said members are made from rebar.

8. The precast concrete pullbox of claim 1, further comprises a cover positioned on an upper end of said at least one sidewall to further define said enclosed volume and provide selective access to said enclosed volume.

9. A method of forming a precast concrete pullbox for enclosing utility components, comprising:
providing a mold having a central core and at least one mold plate, wherein said at least one mold plate has an inwardly-oriented protrusion that defines a knockout section with a reduced thickness;
wrapping a reinforcement mesh around said central core, wherein said reinforcement mesh comprises a plurality of horizontal members crossing a plurality of vertical members;
positioning said at least one mold plate around said reinforcement mesh and said central core;
pouring a concrete mix into a space between said central core and said at least one mold plate and allowing said concrete mix to cure; and
moving said at least one mold plate away from said central core with a predetermined force to release a resulting pullbox that has said knockout section, wherein a taper surface extends outwardly from a surface of said knockout section to an outer surface of at least one sidewall of said pullbox, and said taper surface has an arcuate top portion and an arcuate bottom portion to promote release of said pullbox from said mold.

10. The method of claim 9, further comprising securing a spacer to a horizontal member or a vertical member of said reinforcement mesh to offset said reinforcement mesh from an outer surface of said central core.

11. The method of claim 9, wherein said at least one mold plate comprises a first mold plate and a second mold plate, wherein said protrusion extends from an inner surface of said first mold plate to define said knockout section, and a second protrusion extends from an inner surface of said second mold plate to define a second knockout section.
